(19) United States
(12) Patent Application Publication
(10) Pub. No.: US 2004/0198376 A1
(43) Pub. Date: Oct. 7, 2004

(54) Method and apparatus for supporting group communications based on location vector

(76) Inventors: Ravinder Chandhok, Poway, CA (US); Kimberly Harvey Chandhok, Poway, CA (US)

Correspondence Address: Qualcomm Incorporated, Patents Department, 5775 Morehouse Drive, San Diego, CA, 92121-1714, US

(21) Appl. No.: 10/208,990

(22) Filed: Jul. 30, 2002

(51) Int. Cl. H04Q 7/20; H04B 7/00

(52) U.S. Cl. 455/456.1; 455/519

(57) ABSTRACT

A method and apparatus for joining a requester of a desired service to a local group of providers for the desired service allows the requester of the desired service to instantly get in touch with the local group of providers for the desired service. The group of service providers is dynamically determined based on the current location vector of the service requester, regardless of the current location of the service requester, and without requiring the service requester to individually contact each provider of the desired service.

### FIELD

The present invention relates to point to multi-point communications systems. More specifically, the present invention relates to methods and apparatus for dynamically joining a user, who has requested for a desired service, to a local group of providers of the desired service, based on the current location as well as the current direction of movement of the user.

### BACKGROUND

When a requester of a desired service wishes to contact some local providers of the desired service, the requester of the desired service needs to have access to a list of contact information, e.g., phone numbers, for such providers of the desired service. The requester also needs to search through such list of phone numbers for some specific providers of the desired service that are in the proximity of the requester's current location. Further, the requester needs to individually contact each local service provider for obtaining information about the desired service as well as the available service provider. The requester needs to repeat this painstakingly process for each local service provider if the requester desires to select a competitive provider for the desired service. Furthermore, when the requester moves into another city or state, the requester has to obtain a new list of contact information for the service providers in the new location. Finding such new list of contact information is often time consuming, and would not be practical in emergency cases, such as when a police, an ambulance, or a road service is urgently desired. Currently, a requester of a desired service cannot instantly get in touch with a group of local providers for the desired service regardless of the current location of the service requester, and without requiring the requester to individually contact each service provider.

For example, a class of wireless services intended for quick, efficient, one-to-one or one-to-many (group) communication has existed in various forms for many years. In general, these services have been half-duplex, where a user presses a “push-to-talk” (PTT) button on a phone/radio to initiate a group call. If granted the floor, the talker then generally speaks for a few seconds. After the talker releases the PTT button, other users may request the floor. These services have traditionally been used in applications where one person, a “dispatcher,” needs to communicate with a group of people, such as field service personnel or taxi drivers, which is where the “dispatch” name for the service comes from. Similar services have been offered on the Internet and are generally known as “voice chat.”

A key feature of these services is that communication is quick and spontaneous, usually initiated by simply pressing a PTT button, without going through a typical dialing and ringing sequence. Communication in this type of service is generally very short, with individual talk “spurts” being generally on the order of several seconds, and “conversations” lasting possibly a minute or less. The time delay between when the user requests the floor and when the user receives a positive or negative confirmation from a group server indicating that the user has the floor and may begin speaking is known as PTT latency. PTT latency is a critical parameter for half-duplex group communications systems. As mentioned previously, dispatch services place a priority on short, quick conversations, which makes the service less effective if PTT latency becomes large.

There is a need, therefore, for mechanisms to allow a requester of a desired service to instantly get in touch with a local group of available providers for the desired service, regardless of the current location and/or direction of movement of the service requester, and without requiring the service requester to individually contact each service provider.

### SUMMARY

The disclosed embodiments provide novel and improved methods and apparatus for joining a communication device (CD) to a group of service providers in a global communication network. In one aspect, the method provides for receiving a request from the CD for joining a group of service providers for a desired service, determining a current location vector of the CD, determining a group of providers for the desired service based on the determined current location vector of the CD, and joining the CD to the determined group.

In one aspect, a method in a communication device (CD) for joining a group of service providers in a global communication network provides for sending a request from the CD to a group server (GS) for joining a group of service providers for a desired service, providing a current location vector of the CD to the GS, and receiving a response indicating that the GS has joined the CD to a group of service providers, which provides for the desired service, based on the current location vector of the CD.

In one aspect, an apparatus for joining a communication device (CD) to a group of service providers in a global communication network includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description of the embodiments set forth below when taken in conjunction with the following drawings:

FIG. 1 illustrates a group communications system;

FIG. 2 illustrates an embodiment for a base station and a mobile station in FIG. 1;

FIG. 3 illustrates how several communication devices interact with a group server;

FIG. 4 illustrates one embodiment for the group server operating in FIG. 1;

FIG. 5 illustrates a message flow diagram for joining a group service; and

FIG. 6 illustrates a mapping diagram for a target group identification process.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

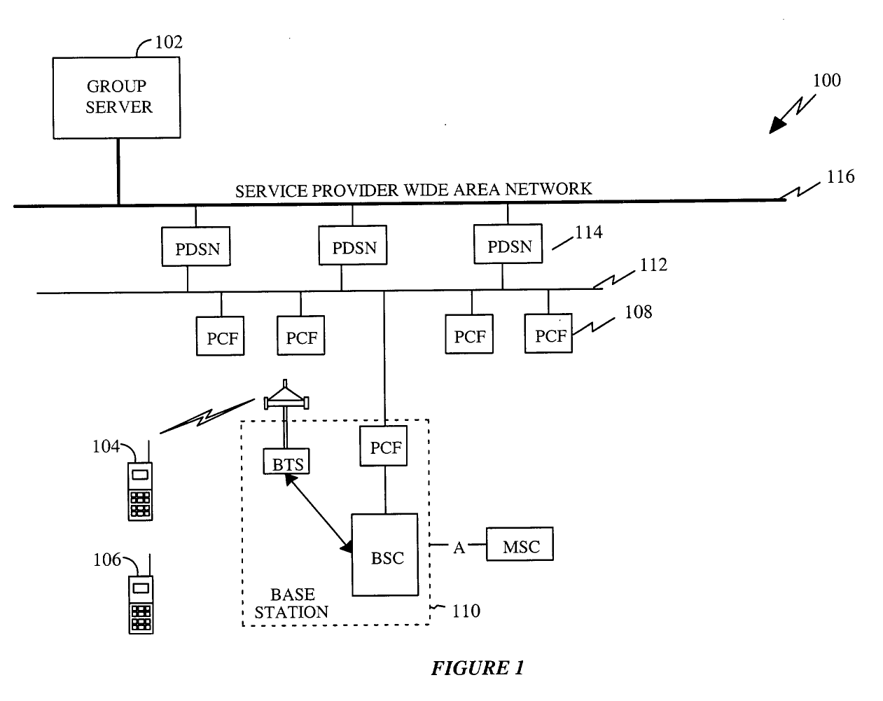

FIG. 1 illustrates a functional block diagram of a group communication system 100, for implementing one embodiment. Group communication system 100 may include a push-to-talk (PTT) system, a net broadcast service (NBS), a dispatch system, or a point-to-multi-point communication system. In one embodiment, group communication system 100 includes a group server 102, which may be deployed in either a centralized deployment or a regionalized deployment.

Group communication devices (CDs) 104 and 106, which may be deployed such as cdma2000 handset, for example, may request packet data sessions using a data service option. Each CD may use the session to register its Internet Protocol (IP) address with the group server to perform group call initiations. In one embodiment, group server 102 is connected to the service provider's packet data service nodes (PDSNs) through a service provider's wide area network 116. CDs 104 and 106, upon requesting packet data sessions from the wireless infrastructure, may have IP connectivity to group server 102 through a PDSN 114. The PDSNs provide interface between transmission of data in the fixed network and the transmission of data over the air interface. Each PDSN may interface to a base station controller (BSC) through a packet control function (PCF) 108 and a network 112. The PCF may be co-located with the BSC within a base station (BS) 110.

A packet data service node may fall in one of several states, e.g., active or connected state, dormant state, and null or inactive state. In the active or connected state, an active traffic channel exists between the participating CD and the BS or BSC, and either side may send data. In the dormant state, no active traffic channel exists between the participating CD and the BSC, but a point-to-point (PPP) link is maintained between the participating CD and the PDSN. In the null or inactive state, there is no active traffic channel between the participating CD and the BSC, and no PPP link is maintained between the participating CD and the PDSN.

After powering up, CDs 104 and 106 may request packet data sessions. As part of establishing a packet data session, each CD may be assigned an IP address. Each CD may perform a registration process to notify group server 102 of the CD's IP address. Registration may be performed using an IP protocol, such as session initiation protocol (SIP) over user datagram protocol (UDP). The IP address of a CD may be used to contact the CD when the corresponding user is invited into a group call.

Once a group call is established, CDs 104 and 106 and group server 102 may exchange media and signaling messages. In one embodiment, media may be exchanged between the participating CDs and the group server by using real-time protocol (RTP) over UDP. The signaling messages may also be exchanged by using a signaling protocol over UDP.

Group communication system 100 performs several different functions in order to operate group call services. The functions that relate to the user side include user registration, group server initiation, group server termination, sending alerts to group participants, late join to a group call, talker arbitration, adding members to a group, removing members from a group, un-registering a member, and authentication. The functions that relate to system preparation and operation include administration and provisioning, scalability, and reliability.

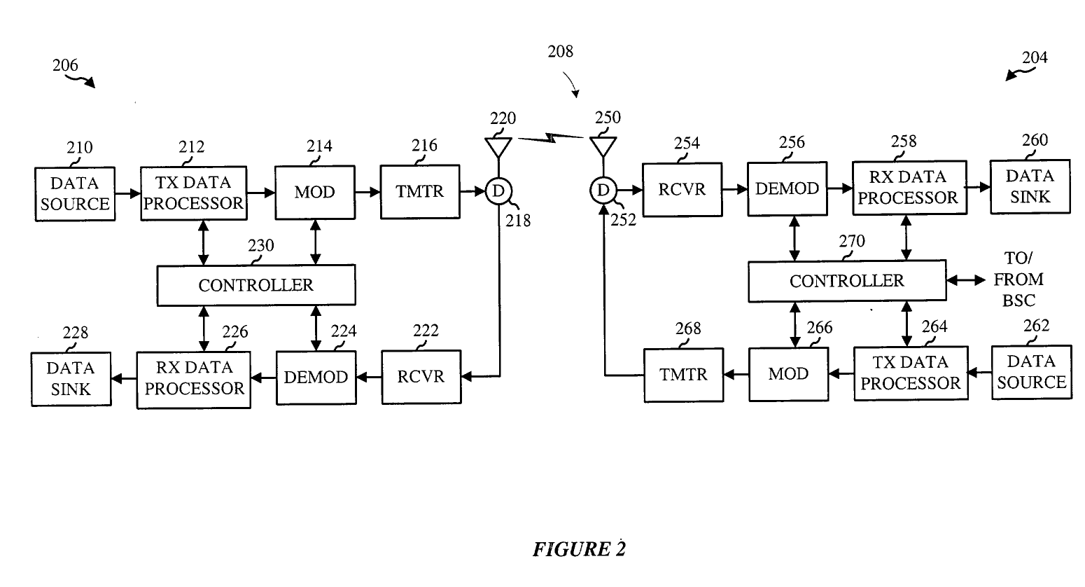

FIG. 2 is a simplified block diagram of an embodiment of base station 204 and mobile station 206, which are capable of implementing various disclosed embodiments. For a particular communication, voice data, packet data, and/or messages may be exchanged between base station 204 and mobile station 206, via an air interface 208. Various types of messages may be transmitted, such as messages used to establish a communication session between the base station and mobile station, registration and paging messages, and messages used to control a data transmission (e.g., power control, data rate information, acknowledgment, and so on). Some of these message types are described in further detail below.

For the reverse link, at mobile station 206, voice and/or packet data (e.g., from a data source 210) and messages (e.g., from a controller 230) are provided to a transmit (TX) data processor 212, which formats and encodes the data and messages with one or more coding schemes to generate coded data. Each coding scheme may include any combination of cyclic redundancy check (CRC), convolutional, turbo, block, and other coding, or no coding at all. The voice data, packet data, and messages may be coded using different schemes, and different types of messages may be coded differently.

The coded data is then provided to a modulator (MOD) 214 and further processed (e.g., covered, spread with short PN sequences, and scrambled with a long PN sequence assigned to the user terminal). The modulated data is then provided to a transmitter unit (TMTR) 216 and conditioned (e.g., converted to one or more analog signals, amplified, filtered, and quadrature modulated) to generate a reverse link signal. The reverse link signal is routed through a duplexer (D) 218 and transmitted via an antenna 220 to base station 204.

At base station 204, the reverse link signal is received by an antenna 250, routed through a duplexer 252, and provided to a receiver unit (RCVR) 254. Base station 204 may receive registration information and location vector information, e.g., mobile station mobility rate, from mobile station 206. Receiver unit 254 conditions (e.g., filters, amplifies, down converts, and digitizes) the received signal and provides samples. A demodulator (DEMOD) 256 receives and processes (e.g., despreads, decovers, and pilot demodulates) the samples to provide recovered symbols. Demodulator 256 may implement a rake receiver that processes multiple instances of the received signal and generates combined symbols. A receive (RX) data processor 258 then decodes the symbols to recover the data and messages transmitted on the reverse link. The recovered voice/packet data is provided to a data sink 260 and the recovered messages may be provided to a controller 270. Controller 270 includes instructions for paging a group of mobile stations. Controller 270 also includes instructions for determining or receiving a location vector, e.g., location and direction of movement of the mobile station. Controller 270 further includes instructions for determining a local group of service providers based on the current location vector and the desired service requested by the user, and joining the mobile station to the group.

The processing by demodulator 256 and RX data processor 258 are complementary to that performed at mobile station 206. Demodulator 256 and RX data processor 258 may further be operated to process multiple transmissions received via multiple channels, e.g., a reverse fundamental channel (R-FCH) and a reverse supplemental channel (R-SCH). Also, transmissions may be simultaneously from multiple mobile stations, each of which may be transmitting on a reverse fundamental channel, a reverse supplemental channel, or both.

On the forward link, at base station 204, voice and/or packet data (e.g., from a data source 262) and messages (e.g., from controller 270) are processed (e.g., formatted and encoded) by a transmit (TX) data processor 264, further processed (e.g., covered and spread) by a modulator (MOD) 266, and conditioned (e.g., converted to analog signals, amplified, filtered, and quadrature modulated) by a transmitter unit (TMTR) 268 to generate a forward link signal. The forward link signal is routed through duplexer 252 and transmitted via antenna 250 to mobile station 206. Forward link signals include paging signals.

At mobile station 206, the forward link signal is received by antenna 220, routed through duplexer 218, and provided to a receiver unit 222. Receiver unit 222 conditions (e.g., down converts, filters, amplifies, quadrature modulates, and digitizes) the received signal and provides samples. The samples are processed (e.g., despreaded, decovered, and pilot demodulated) by a demodulator 224 to provide symbols, and the symbols are further processed (e.g., decoded and checked) by a receive data processor 226 to recover the data and messages transmitted on the forward link. The recovered data is provided to a data sink 228, and the recovered messages may be provided to controller 230. Controller 230 includes instructions for registering mobile station 206. Controller 230 also includes instructions for determining or receiving location vector, e.g., location and direction of movement of the mobile station, and providing the location vector to the group communication server. Controller 230 further includes instructions for determining a local group based on the current location vector and the desired service requested by the user, and joining the mobile station to the group.

The group server may allow one user to communicate, e.g., talk to a group of users in a half-duplex or full-duplex mode. In the former case, because only one person may be permitted to talk at a time, the permission to talk may be moderated by the infrastructure. A user may request permission to talk by pressing a “push-to-talk” button (PTT), for example. The system may arbitrate the requests received from multiple users and, through a contention-resolution process, the system may choose one of the requestors according to a predetermined algorithm. The system may then notify the chosen user that the user has permission to talk. The system may transparently dispatch the user's traffic information, such as voice and/or data, from the authorized talker to the rest of the group members, who may be considered “listeners.” The voice and/or data traffic in group server may be different from the classical one-to-one phone call, and a priority may be placed on some conversations.

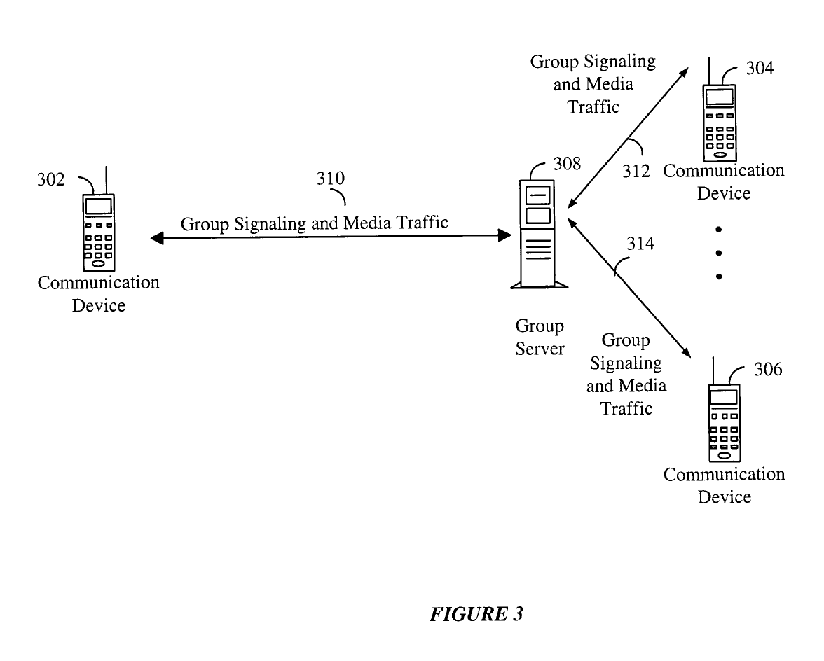

FIG. 3 illustrates a group service arrangement for showing how CDs 302, 304, and 306 interact with group server 308. Multiple group servers may be deployed as desired for large-scale groups. In FIG. 3, when CD 302 has permission to transmit media to other members of the group, CD 302 is known as the talker and may transmit media over an established channel. When CD 302 is designated as the talker, the remaining participants, CD 304 and CD 306, may not have permission to transmit media to the group. Accordingly, CD 304 and CD 306 are designated as listeners. As described above, CDs 302, 304, and 306 are connected to group server 308, using at least one channel. In one embodiment, the channel may include a session initiation protocol (SIP) channel, a media-signaling channel, and a media traffic channel.

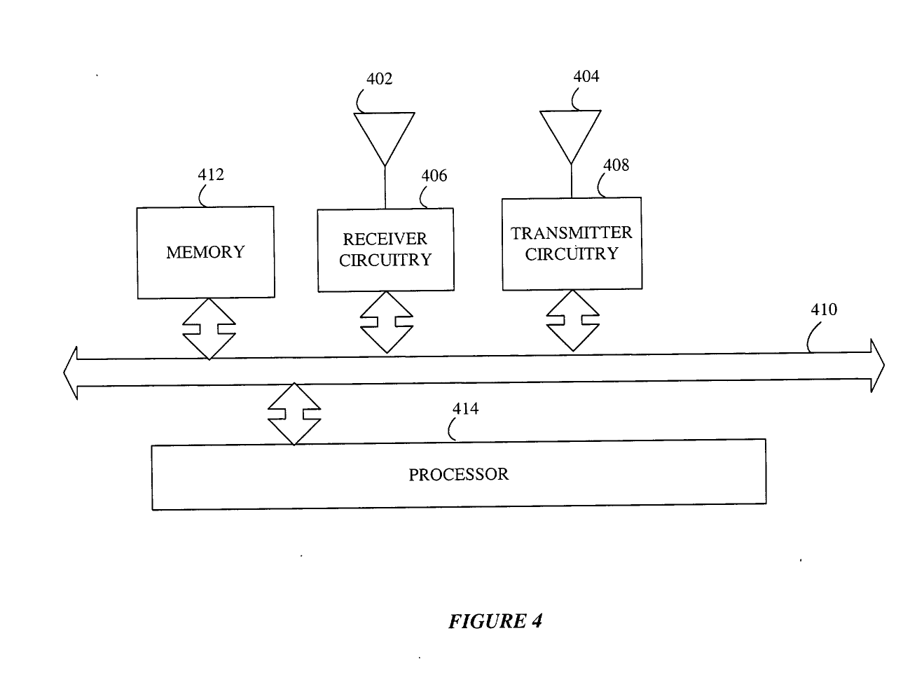

FIG. 4 illustrates one embodiment for the group server 102 operating in system of FIG. 1. The group server includes antennas 402, 404 for transmitting and receiving data. Antenna 402 is coupled to the receiver circuitry 406 and antenna 404 is coupled to the transmit circuitry 408. Communication bus 410 provides a common connection among other modules in FIG. 4. Communication bus 410 is further coupled to memory unit 412. Memory 412 stores computer readable instructions for a variety of operations and functions performed by the group server. The processor 414 performs the instructions stored in memory 412.

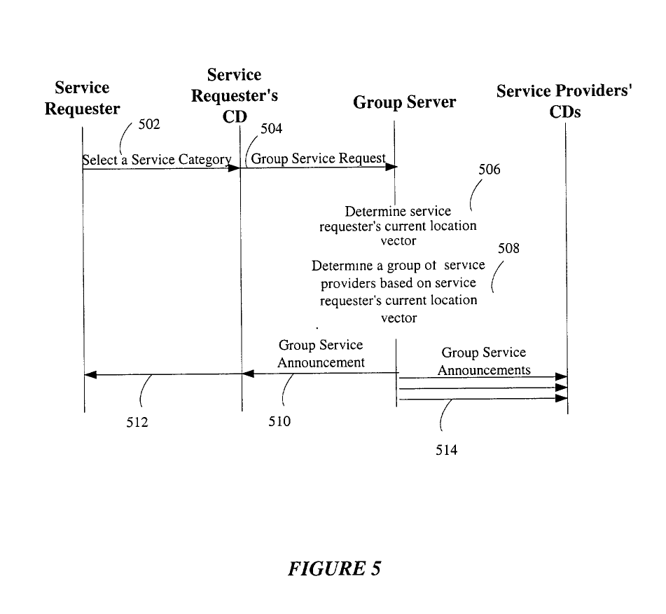

FIG. 5 illustrates a message-flow diagram showing a process for joining a group service, according to one embodiment. A user who wishes to join a group of providers for a desired service may select the desired service category 502 on a CD. The service category may include group call services, such as “traffic condition,” “road condition,” police,” “ambulance,” and “road service.” The service category may also include Internet services, such as Internet chat room and data services, e.g., subscription information publishing services. The requester's CD may then send a group service request 504 to a group server to setup a group service with some providers for the selected service category.

After the group server receives the group service request 504, the group server determines a current location vector 506 for the requester's CD. The current location vector includes information about the current location and/or the current direction of movement of the requester's CD. The group server determines the direction of movement of the requester's CD by using samples of location and/or speed of movement over time. The group server receives the current location vector from the requester's CD, through some registration or paging process supported by the underlying wireless infrastructure, e.g., cdma2000. After the group server determines the current location vector 506 of the requester's CD, the group server may determine a group of providers 508 of the selected service based on the determined current location vector of the requester's CD. This may be done by mapping the current location vector to known, e.g., named, groups or ad-hoc, e.g., un-named, groups of service providers.

The group server then sends a group service announcement 510 back to the requester's CD indicating that a group service is being set up with a target group of providers of the desired service. The service requester's CD also informs 512 the service requester e.g., via text, audio, or video, that the service requester is being connected to the target group of the providers of the desired service. According to one embodiment, the service requester's CD optimistically allows the requester to start providing media, and the service requester's CD buffers the media that it receives from the service requester for future transmission to the group server.

The group server may use the location information of the target service providers' CDs to send out group announcements 514 to the target service providers' CDs. Sending the announcements may trigger the communication links, e.g., packet data sessions of the target service providers' CDs to come out of dormancy and to re-establish their traffic channels, if the CDs were in dormant state.

In one embodiment, the group communication system supports both chat-room and ad-hoc group membership models for group services. In the chat-room model, groups are predefined, which may be stored on the group server. The predefined groups, or nets, may be public, implying that the group has an open member list. In this case, each group member is a potential participant in a group services. The group service is started when a first group member starts to initiate the group service. The call remains running for a pre-determined time period, which may be configured by the group server. During a group service, the group members may specifically request to join or leave the group service. During periods of inactivity, the group service may be brought into a group dormant state until a group member requests permission to input media. When operating in the chat-room model, group members, also known as net members, communicate with one another using a communication device assigned to each net member.

In the ad-hoc group membership model of group services, however, groups may be defined in real-time and have a closed member list associated with each group. A closed member list may specify which members are allowed to participate in the group service. The member list may not be available to others outside of the closed member list, and may only exist for the life of the group service. Ad-hoc group definitions may not be stored in the group server. The definitions may be used to establish the group service and released after the call has ended. An ad-hoc group may be formed after a service requester selects a desired service category and generates a group service request, which is sent to the group server to start the group service. The group server may send a notification to the target service provider that they have been included in the group. The group server may automatically join the target service providers to the group service, i.e., no action may be required from the target members. When an ad-hoc group service becomes inactive, the group server may “tear down” the group service and free the resources assigned to the group, including the group definition used to start the service.

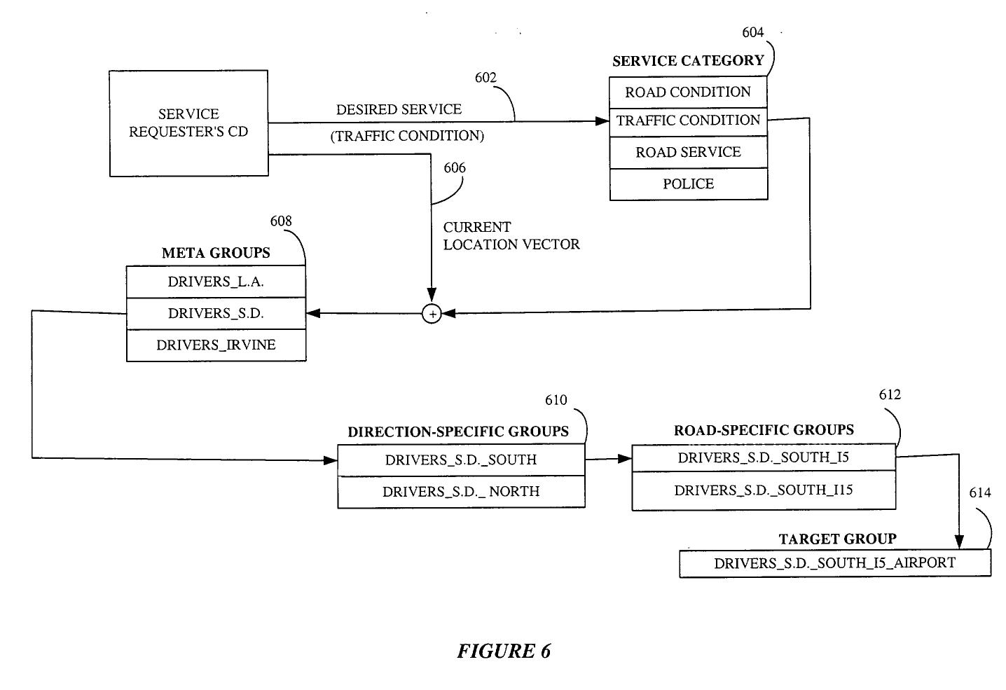

FIG. 6 shows a mapping diagram for identifying a target group of service providers for a desired service, according to one embodiment. After a service requester selects a desired service category, the service requester's CD provides an indication of the selected service 602 to a group server. The group server matches the selected service category with a list of service categories 604. The list of service categories 604 may be kept in the group server or in another entity in the network. The service requester's CD sends the current location vector 606, e.g., current location and direction, of the requester's CD to the group server. The group server uses the current location vector 606 of the service requester's CD and the desired service category 604 to determine a Meta group of providers 608 for the desired service.

For example, the service requester may be a deriver on a road who wishes to find out traffic condition ahead on the road. The service requester selects the service category of “traffic condition” on his or her CD. The group server determines a Meta group 608 based on the selected service category and the current location vector of the service requester. If the location information indicates that the service requester's CD is currently located in the city of San Diego (S.D.), the group server determines a Meta group 608, which may be identified by “Drivers_S.D.” that designates drivers in the city of San Diego who have registered with the group server. Further, if the location vector indicates that the requester's CD is currently moving in southbound in the city of San Diego, the group server determines a direction-based group of service providers 610, which may be identified by “Drivers_S.D._South” that designates drivers currently driving southbound in the city of San Diego, which may encompass more than one north-south route.

If there were more than one north-south route in the city of San Diego, the location information of the driver may be used to identify the group of drivers currently driving southbound on a route that is in closer proximity to the driver. However, if the driver is determined to be an equidistant from two or more such routes, the drivers on such routes who are driving southbound may be combined to form a target group.

For example, if the driver is driving southbound close to I-5 southbound, the group server determines a target group of drivers 612, which may be identified by “Drivers_S.D._South_{—I}5.”

The service requester's CD or the group server may determine the group of service providers who are confined to a limited area. For example, if the service requester is driving on “15” southbound toward the San Diego airport, the group of drivers in the same direction ahead of the service requester who are closer to the San Diego airport are grouped, as the target group 611, which may be identified by “Drivers_S.D._South_{—I}5_Airport,” that designates drivers who potentially can provide better information on road condition leading to the San Diego airport. Therefore, the service requester, who wishes to know traffic condition ahead on the road, is instantly joined to a group of drivers who are ahead in a desired area on the road.

The group server may determine a local group of providers of the desired service based on a current location vector of the requester's CD in several ways. In one embodiment, the group server determines the target group of service providers based on the current location and current direction of movement of the requester's CD. In one embodiment, the target group includes a predetermined or fixed group of providers of the desired service, which group may be mapped to the current location vector of the service requester's CD. In one embodiment, the target group is formed dynamically from a group of available providers of the desired service, whose current location vectors match with the current location vector of the service requester's CD. In one embodiment, the group includes a group of providers of the desired service who are currently within a region around the current location of the service requester's CD and moving in the same direction of movement. The region may be an area defined by a predetermined radius around the current location of the requester's CD. The region may be a fixed area around the current location of the requester's CD, or a dynamically configured area based on the current location of the service requester's CD, the current direction of movement of the service requester's CD, the traffic density and patterns of where the driver is currently located, and/or availability of service providers who are close to the current location of the service requester.

Therefore, the disclosed embodiments provide for instantly joining a requester of a desired service to a local group of available providers for the desired service, based on the current location and direction of movement of the service requester. Advantageously, the requester of the desired service does not need to carry contact information for the providers of the desired service, dos not need to search through such contact information for a nearby or local service provider, and does not need to individually contact each service provider for obtaining information about the desired service. Additionally, the requester is instantly put in contact with a group of service providers who are located in the same neighborhood that the requester is located, even when the requester's current location and direction are changing.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

1. A method in a group communication server for joining a communication device (CD) to a group in a global communication network, the method comprising:
receiving a request from the CD for a desired service;
determining a current location vector of the CD;
determining a group of providers for the desired service based on the current location vector; and
joining the CD to the group.

2. The method of claim 1, wherein said determining the current location vector includes receiving the current location vector from the CD.

3. The method of claim 1, wherein said determining the group further includes determining a predetermined group of providers for the desired service.

4. The method of claim 1, wherein said determining the group further includes determining a dynamically formed group of providers for the desired service.

5. The method of claim 3, wherein said determining the group further includes determining the group of providers moving in the same direction in which the CD is moving.

6. The method of claim 5, wherein said determining the group further includes determining the group of providers located in a limited area.

7. A method in a communication device (CD) for joining a group in a global communication network, the method comprising:
sending a request from the CD to a group server (GS) for a desired service;
providing a current location vector of the CD to the GS; and
receiving a response indicating that the GS has joined the CD to a group of service providers for the desired service.

8. The method of claim 7, wherein said group is determined based on the current location vector of the CD.

9. The method of claim 8, wherein said group is further determined based on a predetermined group of providers for the desired service.

10. The method of claim 8, wherein said group is further determined based on a dynamically formed group of providers for the desired service.

11. The method of claim 8, wherein said group is further determined based on the group of providers moving in the same direction in which the CD is moving.

12. The method of claim 11, wherein said group is further determined based on the group of providers located in a limited area.

13. A computer-readable medium embodying a method for joining a communication device (CD) to a group call in a wireless communication network, the method comprising:
receiving a request from the CD for a desired service;
determining a current location vector of the CD;
determining a group of service providers for the desired service based on the current location vector; and
joining the CD to the group.

14. The computer-readable medium of claim 13, wherein said determining the current location vector includes receiving the current location vector from the CD.

15. The computer-readable medium of claim 13, wherein said determining the group further includes determining a predetermined group of service providers for the desired service.

16. The computer-readable medium of claim 13, wherein said determining the group further includes determining a dynamically formed group of providers for the desired service.

17. The computer-readable medium of claim 13, wherein said determining the group further includes determining the group of providers moving the same direction in which the CD is moving.

18. The computer-readable medium of claim 17, wherein said determining the group further includes determining the group of providers located in a limited area.

19. A computer-readable medium in a communication device (CD) for joining a group call in a wireless communication network, the method comprising:
sending a request from the CD to a group server (GCS) for a desired service;
providing a current location vector of the CD to the GCS; and
receiving a response indicating that the GCS has joined the CD to a group of providers for the desired service.

20. The computer-readable medium of claim 19, wherein said group is determined based on the current location vector of the CD.

21. The computer-readable medium of claim 20, wherein said group is further determined based on a predetermined group of providers for the desired service.

22. The computer-readable medium of claim 20, wherein said group is further determined based on a dynamically formed group of providers for the desired service.

23. The computer-readable medium of claim 19, wherein said group is further determined based on the group of providers moving the same direction in which the CD is moving.

24. The computer-readable medium of claim 23, wherein said group is further determined based on the group of providers located in a limited area.

25. A server for joining a communication device (CD) to a group call in a wireless communication network, comprising:
means for receiving a request from the CD for a desired service;
means for determining a current location vector of the CD;
means for determining a group of service providers for the desired service based on the current location vector; and
means for joining the CD to the group.

26. The server of claim 25, wherein said means for determining the current location vector includes means for receiving the current location vector from the CD.

27. The server of claim 25, wherein said means for determining the group includes means for determining a predetermined group of providers for the desired service.

28. The server of claim 25, wherein said means for determining the group includes means for determining a dynamically formed group of providers for the desired service.

29. The server of claim 25, wherein said means for determining the group includes means for determining the group of providers moving the same direction in which the CD is moving.

30. The server of claim 29, wherein said means for determining the group includes means for determining the group of providers located in a limited area.

31. A communication device (CD) for joining a group call in a wireless communication network, comprising:
means for sending a request from the CD to a group server (GCS) for a desired service;
means for providing a current location vector of the CD to the GCS; and
means for receiving a response indicating that the GCS has joined the CD to a group of providers for the desired service.

32. The communication device of claim 36, wherein said group is determined based on the current location vector of the CD.

33. The communication device of claim 32, wherein said group is further determined based on a predetermined group of providers for the desired service.

34. The communication device of claim 32, wherein said group is further determined based on a dynamically formed group of providers for the desired service.

35. The communication device of claim 32, wherein said group is determined based on the group of providers moving the same direction in which the CD is moving.

36. The communication device of claim 35, wherein said group is further determined based on the group of providers located in a limited area.

37. An server for joining a communication device (CD) to a group call in a wireless communication network, comprising:
a memory unit;
a receiver;
a transmitter; and
a processor coupled to the memory unit, the receiver, and the transmitter, the processor being capable of:
receiving a request from the CD for a desired service;
determining a current location vector of the CD;
determining a group of providers for the desired service based on the current location vector; and
joining the CD to the group.

38. The server of claim 37, wherein said determining the current location vector includes receiving the current location vector from the CD.

39. The server of claim 37, wherein said determining the group further includes determining a predetermined group of providers for the desired service.

40. The server of claim 37, wherein said determining the group further includes determining a dynamically formed group of providers for the desired service.

41. The server of claim 37, wherein said means for determining the group includes means for determining the group of providers moving the same direction in which the CD is moving.

42. The server of claim 41, wherein said determining the group further includes determining the group of providers located in a limited area.

43. A communication device (CD) for joining a group call in a wireless communication network, comprising:
a memory unit;
a receiver;
a transmitter; and
a processor coupled to the memory unit, the receiver, and the transmitter, the processor being capable of:
sending a request from the CD to a group server (GCS) for a desired service;
providing a current location vector of the CD to the GCS; and
receiving a response indicating that the GCS has joined the CD to a group of providers for the desired service.

44. The CD claim 43, wherein said group is determined based on the current location vector of the CD.

45. The CD of claim 44, wherein said group is further determined based on a predetermined group of providers for the desired service.

46. The CD of claim 44, wherein said group is further determined based on a dynamically formed group of providers for the desired service.

47. The CD of claim 44, wherein said group is determined based on the group of providers moving the same direction in which the CD is moving.

48. The CD of claim 47, wherein said group is further determined based on the group of providers located in a limited area.
